(19) United States
(12) Patent Application Publication
(10) Pub. No.: US 2022/0138437 A1
(43) Pub. Date: May 5, 2022

(54) METHODS AND SYSTEMS FOR INTEGRATING MACHINE TRANSLATIONS INTO SOFTWARE DEVELOPMENT WORKFLOWS

(71) Applicant: INTUIT INC., Mountain View, CA (US)

(72) Inventor: Garry Aaron BULLOCK, Edmonton (CA)

(73) Assignee: INTUIT INC., Mountain View, CA (US)

(21) Appl. No.: 17/085,267

(22) Filed: Oct. 30, 2020

(51) Int. Cl. G06F 40/47; G06F 40/263; G06F 11/36; G06F 8/41

(52) U.S. Cl. CPC G06F 40/47; G06F 40/263; G06F 8/447; G06F 11/3692; G06F 11/3624

(57) ABSTRACT

A machine translation system translates translatable strings included in code submissions submitted to a target repository. The machine translation system incorporates translated code submissions into one or more target repositories to generate global ready code that may be deployed in a variety of different language-specific versions of a software platform. The machine translation system is integrated into a software development process to improve the speed and efficiency of new code development and the quality of software platforms.

### BACKGROUND

Global software platforms are deployed in many different countries around the world. To build trust and confidence among platform users, it is important that the language of text displayed within the software platform match the local language of the country where the platform is accessed. Therefore, it is desirable to develop and release local language versions of the software platform in each country where it is deployed. To streamline development and testing of each local language version, it is desirable to integrate translations of text and other translatable components of the software into the software development process. A system for integrating machine translations into existing software development workflows would reduce development time and improve the quality of the local language versions of the software platform.

### BRIEF DESCRIPTION OF THE FIGURES

FIG. 1 is a flow diagram illustrating an example machine translation process according to various embodiments of the present disclosure.

FIG. 2 shows an example system configured to generate machine translations according to various embodiments of the present disclosure.

FIG. 3 shows more details of the example system of FIG. 2 according to various embodiments of the present disclosure.

FIG. 4 shows more details of the example system of FIG. 3 according to various embodiments of the present disclosure.

FIG. 5 illustrates an example user interface (UI) for tagging code submissions that require translations according to various embodiments of the present disclosure.

FIG. 6 is a block diagram illustrating an example computing device according to an embodiment of the present disclosure.

### DETAILED DESCRIPTION OF SEVERAL EMBODIMENTS

The disclosed machine translation approach translates text strings and other translatable portions of code submissions. The translated strings are then integrated back into the original code submission to generate translated code submissions that are pushed to language and location specific code repositories. Existing tools for developing and managing code and translating text are separate. The disclosed machine translation system improves upon existing machine translation systems by integrating machine translations with tools for developing code (i.e., version control software for managing code repositories). By integrating machine translations into the software development workflow, the machine translation system reduces overall development time for new code submissions and improves the quality of location specific versions of software platforms.

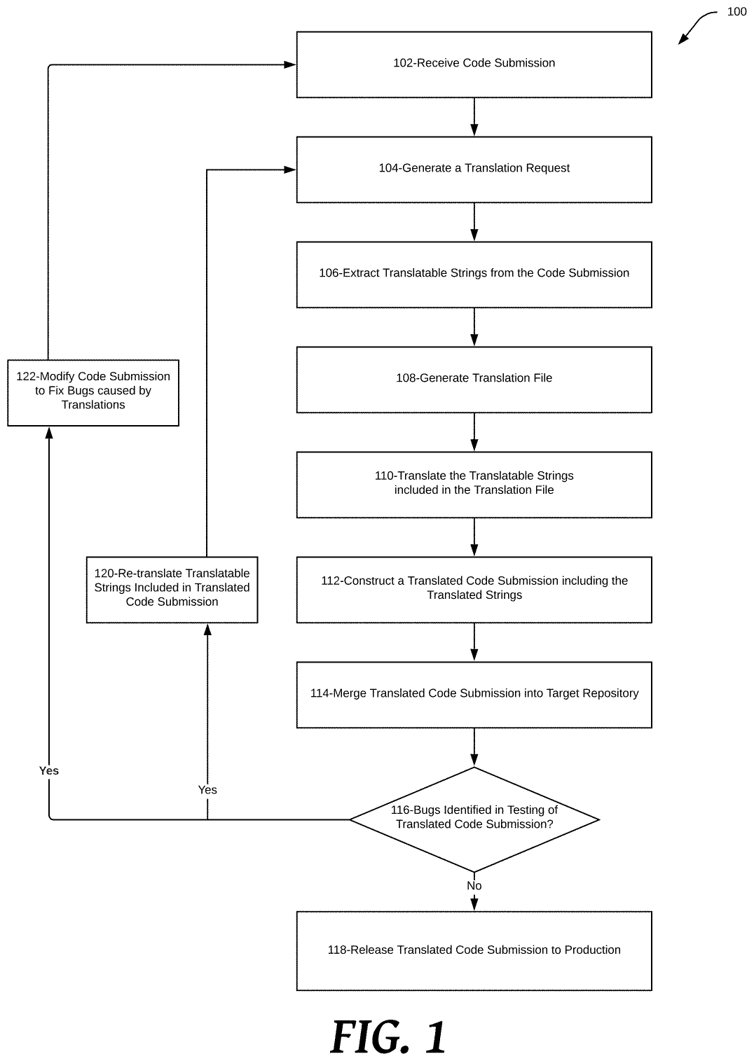

FIG. 1 is a block diagram illustrating an example process 100 for machine translation in accordance with the disclosed principles. The translation process 100 is integrated into a software development process to streamline development and testing of location-specific versions software platforms. At step 102, the machine translation system receives a code submission. The code submission may be previously uploaded to a source repository storing a software platform. The code submission may also include changes and or updates to one or more files included in the source repository. The code submission may include multiple files such as e.g., executable code and resources. The executable code may include multiple lines of computer code that provide one or more functions of a computer program. The resources may include text, colors, images and other media files, and other data that are consumed by the multiple lines of computer code. The code submission may be received from a source repository or other storage unit managed by a version control service. To initiate translation, the code submission may be marked as requiring machine translation within the version control service using a tag or label. The code submission may also be reviewed by the machine translation system to automatically identify one or more files and or strings of text that require translation.

At step 104, the machine translation system generates a translation request for the code submission. The translation request may include a translation event, the code submission tagged for translation, and or translation meta-data describing the translation event. For example, the translation meta-data may include identification information for the code submission, the source repository where the code submission resides, the one or more target repositories that receive the code submission, and a list of names or other identifiers for the files in the source repository that are changed or added by the code submission. The translation meta-data may also include translation parameters including the locations (e.g., US, Canada, Brazil, Australia) and or languages (e.g., US-English, Canadian-French, Canadian-English, Brazilian-Portuguese) for the source repository and the target repositories that receive the translated code submissions generated by the machine translation system.

The translation parameters may be pulled automatically from the code submission's configuration information. For example, the translation parameters may be obtained from the target repositories receiving the submission and or the source repository including the original upload of the code submission. The target and or source repositories may include configuration information that specifies the languages and or locations that correspond to the repositories. The repository configuration information may also specify the type of files (i.e., computer code, resource, and the like) that are changed and or added by the code submission. For example, each repository's configuration information may include a list of file names, regular expressions, and or other identifiers for files that include text strings and or other translatable components. The translation parameters may be extracted from the repository configuration information to determine whether the code submission includes resource files or other files that include translatable components and, if translation is required, identify the languages for the translation and or the locations where the translated code submission will be released.

The translation parameters may also be obtained from a configuration service that manages the source and or target repositories. The source and or target repositories may not be location aware. Therefore, a configuration service may be used to configure the source and or target repositories to deploy one or more software platforms included in the repositories to a particular location. The configuration service may store the locations and or languages associated with each repository configured by the configuration service. The machine translation system may connect to the configuration service and retrieve the locations and or languages associated with each source and or target repository from the configuration service to determine the languages for translation.

Obtaining the locations and or languages for translation and or other translation parameters from the configuration service may be faster and more efficient than obtaining the locations, languages, and other translation parameters directly from the source and or target repositories. For example, the locations and languages associated with the source and or target repositories may be obtained through an API call or other communication to the configuration service. Generating and transmitting the API call or other communication may require fewer compute operations and less processing resources, memory allocation, and storage relative to methods of extracting the translation parameters directly from the repositories (e.g., downloading and analyzing individual files within the source and or target repositories).

For each code submission requiring translation, the machine translation system may add the translation parameters to the translation meta-data and transfer the translation request to the translation engine. The machine translation system may review each code submission committed to a repository to identify code submissions requiring translation before creating and transferring a translation request to the translation engine. Accordingly, the machine translation system disclosed herein may reduce the amount of translation requests received by the translation engine. By ensuring that only code submissions requiring translations are included in translation requests submitted to the translation engine, the disclosed machine translation system may improve translation speed and increase the efficiency of the translation engine.

In one or more embodiments, translation requests received by the translation engine are queued for batch processing by a dispatcher included in the translation engine. The dispatcher may queue and schedule batch processing of translation requests according to the translation parameters included in the translation meta-data. For example, the dispatcher may queue translation requests based on the locations, languages, and or file types included in each translation request to make sure the translation requests are routed to the correct language model for translation. The dispatcher may also schedule translation requests based on the processing capacity, batch size, and or other configurations of the translation engine. The dispatcher may also schedule translation requests according to the configuration information of the source and or target repository identified in the translation meta-data. For example, the dispatcher may schedule processing of translation requests to limit the number of translation jobs running for a particular target and or source repository.

To begin translation, the dispatcher selects a translation request from the queue and spins up an ephemeral translation processing infrastructure to handle the processing of the request. The ephemeral translation processing infrastructure may include a container or other unit of software that includes all of the tools, resources, and data needed to translate the translatable files included in the translation request. For example, the container may include all code modules, system tools, system libraries, configuration settings, and other data needed to access the files requiring translation, extract the text strings to be translated (i.e., the translatable strings), and translate the extracted text strings. The containers are pushed to a particular processor (e.g., a host server) to execute the translation process.

At step 106, the container extracts multiple translatable strings from the code submission. To extract the translatable strings, the container may use the translation meta-data to access the source repository storing the code submission and obtain all of the files changed and or added by the code submission. An extraction module included in the container may extract the translatable text strings from the retrieved files. To extract the translatable strings, the extraction module may parse a list of files retrieved from the source repository to slice files from the list that include the translatable strings. For example, the extraction module may review the files' names, size, and other meta-data to identify resource files that include translatable strings. The extraction module may also parse a list of files, a file hierarchy, or other file organization structure to slice files having a particular location within the list, hierarchy, and or other organization structure.

The extraction module may also parse an individual file obtained from the source repository to slice portions of the file that include translatable strings from portions of the file that include computer code or other material that does not require translation. For example, the extraction module may parse JSON, XML, or other structured data formats to separate the translatable strings from portions of the file that do not require translation. Individual lines included in the files may also be sliced by the extraction module to separate the translatable strings from the other contents of the file.

At step 108, the extraction module aggregates the extracted translatable strings and generates a translation file. The translation file represents the extracted translatable strings as a common object that represents the translatable strings in a structured data format (e.g., JSON, XML, or another markup language). The structured data representation of the translatable strings included in common object is readable by humans and machines. Accordingly, the common object may be used in a translation process that includes machine translation and human translation. To facilitate translation, the extraction model may add additional information to the translation file. For example, configuration information may be added into a file header or other aspect of the translation file. The configuration information may include, for example, instructions for assessing and reading the translatable strings, security information for authenticating the translation file, and translation parameters. The translation parameters may include the original language of the translatable strings (i.e., the source language associated with the source repository), locations and languages associated with the target repositories receiving the translated code submission, specific technical vocabulary libraries to use during the translation, instructions for handling special characters, acronyms, and or abbreviations, and or similar translation jobs that may include translation results that may be re-used to improve translation speed.

At step 110, the one or more language models of the translation module translate the translatable strings included in the translation file into one or more target languages. The target languages correspond to the locations and or languages associated with the target repositories receiving the translated code submissions. The translation module may identify a language combination indicating a source language of the input translatable strings and a target language for translation based on the configuration information for the source and target repositories included in the translation meta-data. One or more language models for each language combination may be included in the translation module. For example, the translation module may include one or more translation models for performing English to French translations, English to French-Canadian translations, English to Portuguese translations, Chinese to Portuguese translations, French to Dutch translations, and or translations involving any other desirable language combination. The container may determine the language combinations required for a particular translation request based the translation metadata. For example, the language combinations for a particular translation request may be determined using the original language of the translatable strings obtained from the configuration information of the source repository and the locations and or languages included in the configuration information for the target repositories receiving the translated code submission. The container may generate a translation file for each language combination and push the translation files to the translation module. To improve efficiency, the container may also push the same translation file to each set of language models needed to perform the translations for all identified language combinations.

To expedite translation, multiple previously generated translation results may be stored in a set of translation memories. The memory cache including the translation memories may be queried by the translation module to generate translation results instantaneously without using the one or more language models. For example, translations commonly performed for a particular source repository, target repository, software product, software platform, and or type of file (e.g., tax related files, accounting related files, payments related files, medical related files, and the like) may be stored in translation memories. Results for translations stored in the translation memories may be instantaneously generated without using the one or more language models. Generating translation results using the translation memories increases the processing speed of translation operations and reduces the amount of translation operations, processing resources, and memory allocation required to translate the translation file.

The translation module generates translated strings that include translation results for each translatable string included in the translation file. For translation files that include translatable strings that must be translated into multiple languages, the translation module may generate a set of translated strings for each distinct language combination. The translation module pushes the translated strings to the reconstruction module for integration into the non-translatable aspects of the original code submission.

At step 112, the reconstruction module integrates the translated strings with the non-translatable aspects of the code submissions to construct a translated code submission. To generate the translated code submission, the reconstruction module reverses the process of the extraction module by replacing the extracted files and or portions of files with the translated strings. For example, the reconstruction module may parse a list of files, file hierarchy, and or other file organization structure to identify the files included in the code submission that have translatable strings. The reconstruction module may then replace the translatable strings in the identified files with the translated strings and or re-write the identified file including the translated strings. The reconstruction module may also parse JSON, XML, or other structured data formats within a particular file to identify lines and or portions of lines within the file that include translatable strings. The reconstruction module may replace the identified translatable strings included in the file with the corresponding translated strings.

At step 114, the global translation engine merges the files included in the translated code submission into a target repository. For global updates to software platforms that impact versions of the platform deployed in many locations, translated versions of the code submission may be merged into multiple target repositories. For example, a Portuguese version of the code submission may be pushed to a target repository including the Portuguese version of the platform accessible in Brazil, a French version of the code submission may be pushed to a target repository including a French version of the platform accessible in France, and an English version of the code submission may be pushed to a target repository including an English version of the platform accessible in the United States. To push translated code submissions to multiple target repositories, the reconstruction module may construct a translated code submission for each unique location and or language corresponding to at least one of the target repositories. The machine translation system may send a merge request to a version control service to merge each version of the translated code submission into the target repository having the language and or location that corresponds to the translated strings included in the translated code submission. The target repositories receiving the translated code submissions may store a development, staging, and or testing version of the software platform to allow the functionality and or components of the changes and or additions to be tested before the changes are deployed to a production version of the platform.

The translated code submissions merged into the target repositories may be tested at step 116. If no bugs are identified during testing of each change and or addition included in the translated code submissions, the translated code submission may be released to production at step 118. If one or more translation bugs in the translation results are identified during testing, the translatable strings may be re-translated at step 120 to fix the translation bugs. Steps 104-116 may be repeated to re-translate the translatable strings. If one or more programming bugs in the non-translatable aspects of the code submission (e.g., the sizing, layout, format, arrangement of one or more UI components implemented in the lines of executable computer code) are identified during testing, the translated code submission may be modified at step 122 to fix the programming bugs. Steps 102-116 may be repeated to identify changes in the modified translated code submission that require translation and, if necessary, translate the identified translatable strings.

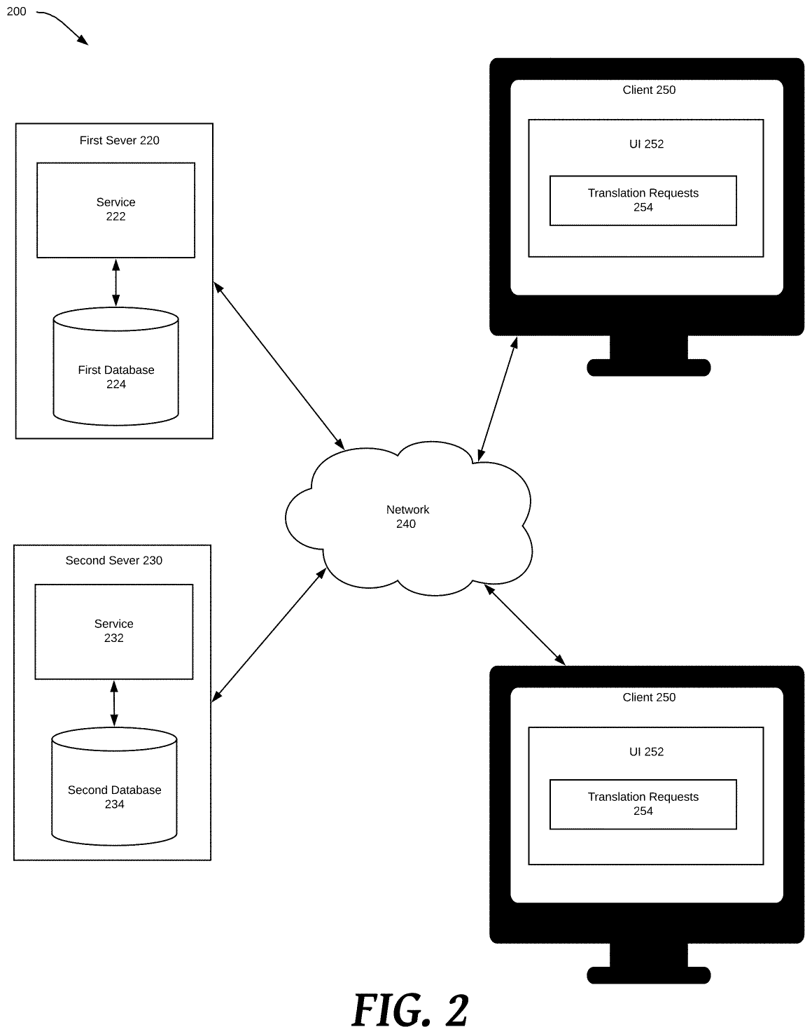

FIG. 2 shows an example system 200 configured to implement a process for machine translation according to an embodiment of the present disclosure. System 200 may include a first server 220, second server 230, and or one or more client devices 250. First server 220, second server 230, and or client device(s) 250 may be configured to communicate with one another through network 240. For example, communication between the elements may be facilitated by one or more application programming interfaces (APIs). APIs of system 200 may be proprietary and/or may be examples available to those of ordinary skill in the art such as Amazon® Web Services (AWS) APIs or the like. Network 240 may be the Internet and/or other public or private networks or combinations thereof.

First server 220 may be configured to implement a first service 222, which in one embodiment may be used to input one or more files of a code submission via network 240 from one or more databases 224, 234, the second server 230 and or client device(s) 250. The first server 220 may execute the process for extracting translatable strings from the one or more files of the code submission and translating the translatable strings into a plurality of languages according to the disclosed principles using language models stored in database 224, database 234, and or received from second server 230 and/or client device(s) 250. First service 222 or second service 232 may implement a version control service, which may manage source repositories and target repositories used to store computer code. The version control service may be any network 240 accessible service that maintains repositories of computer code. The version control service may store target and source repositories having a variety of different language and location configurations. The translation results provided by the system 200 are integrated into the target repositories managed by the version control service to create location and or language specific versions of a software platform.

Client device(s) 250 may be any device configured to present user interfaces (UIs) 252 and receive inputs thereto. The UIs 252 may be configured develop and display code submissions as well as generate translation requests for code submissions including translatable strings. Exemplary client devices 250 may include a personal computer, laptop computer, tablet, smartphone, or other device.

First server 220, second server 230, first database 224, second database 234, and client device(s) 250 are each depicted as single devices for ease of illustration, but those of ordinary skill in the art will appreciate that first server 220, second server 230, first database 224, second database 234, and or client device(s) 250 may be embodied in different forms for different implementations. For example, any or each of the first server 220 and second server 230 may include a plurality of servers or one or more of the first database 224 and second database 234. Alternatively, the operations performed by any or each of first server 220 and second server 230 may be performed on fewer (e.g., one or two) servers. In another example, a plurality of client devices 250 may communicate with first server 220 and/or second server 230. A single user may have multiple client devices 250, and/or there may be multiple users each having their own client device(s) 250.

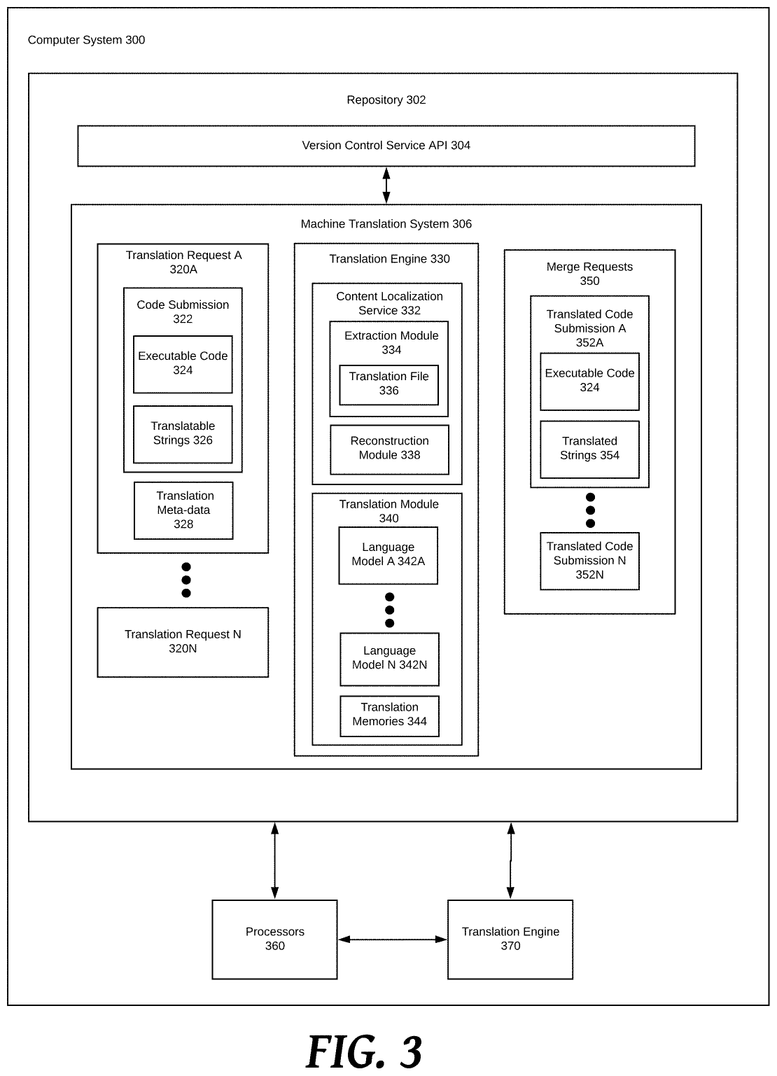

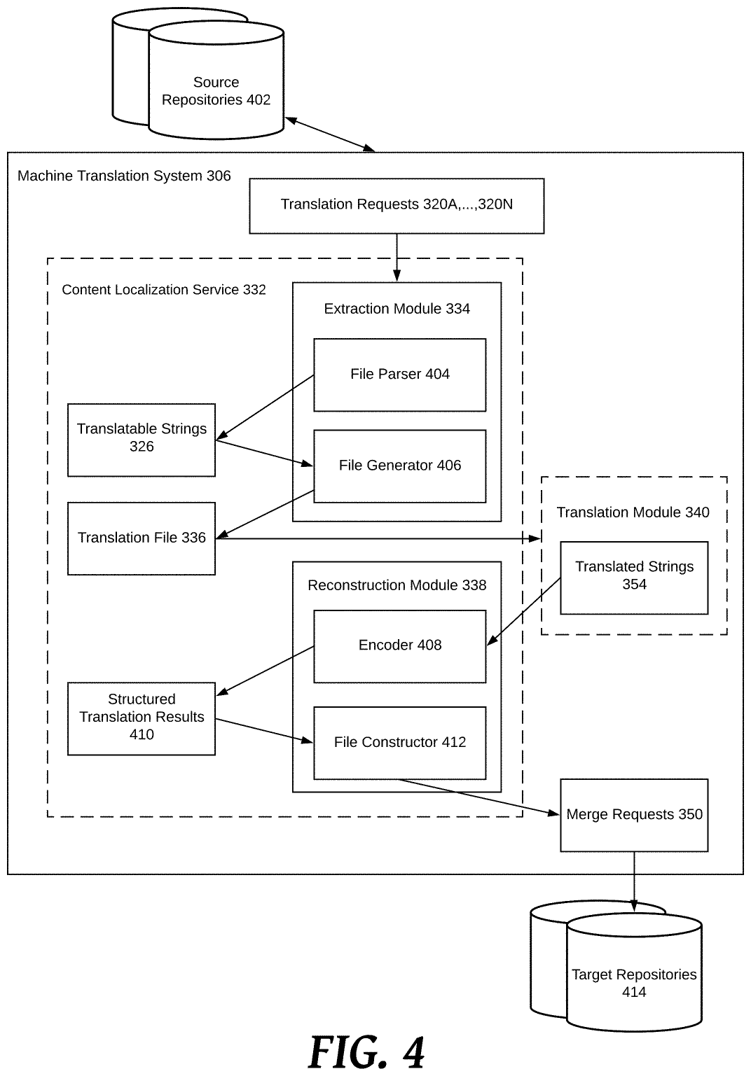

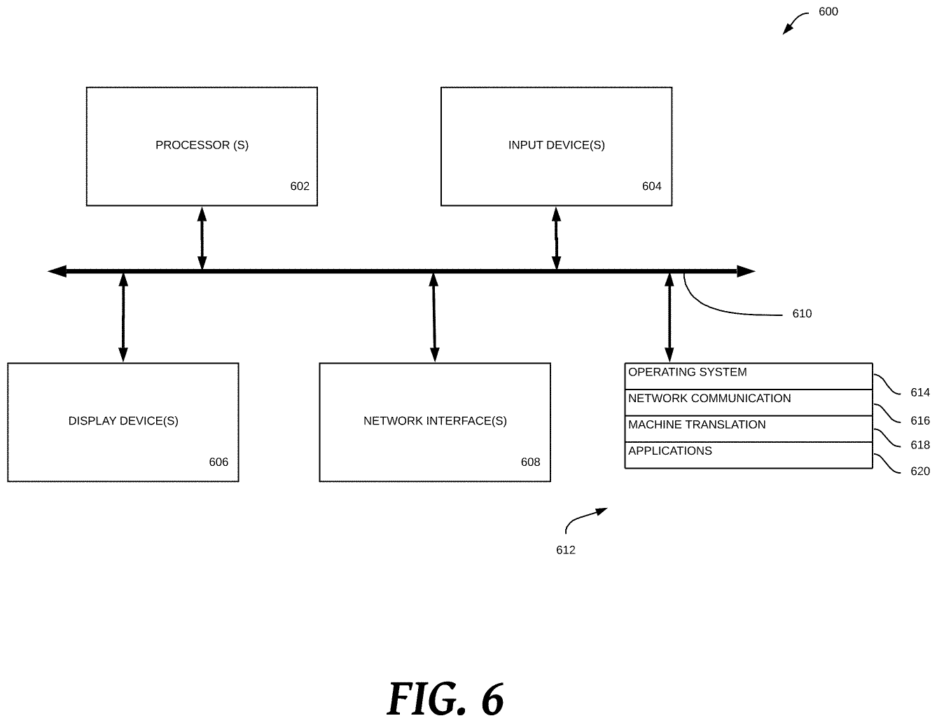

FIGS. 3-4 are block diagrams illustrating an example computer system 300 in accordance with one or more embodiments disclosed herein. As shown in FIG. 3, the computer system 300 includes a repository 302, a translation engine 370, and one or more computer processors 360. In one or more embodiments, the computer system 300 takes the form of the computing device 600 described in FIG. 6 and the accompanying description below or takes the form of the client device 250 described in FIG. 2. In one or more embodiments, the computer processor(s) 340 takes the form of the computer processor(s) 602 described in FIG. 6 and the accompanying description below.

In one or more embodiments, the repository 302 may be any type of storage unit and/or device (e.g., a file system, database, collection of tables, or any other storage mechanism) for storing data. Further, the repository 302 may include multiple different storage units and/or devices. The multiple different storage units and/or devices may or may not be of the same type or located at the same physical site. The repository 302 may include a version control service API 304 and a machine translation system 306.

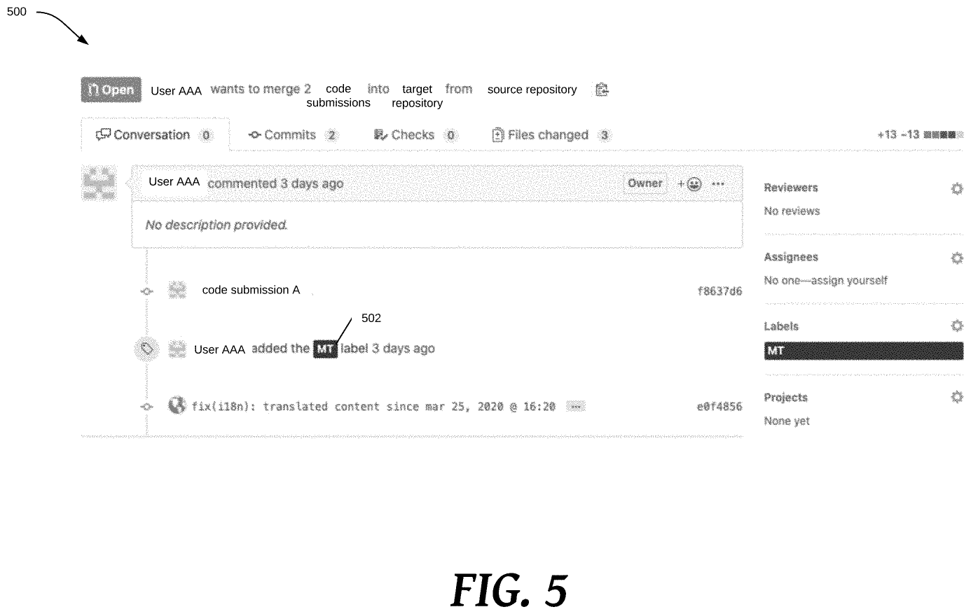

The version control service API 304 allows the computer system to interface with one or more target and or source repositories managed by a version control service. The version control service may be any computer service that stores, configures, updates, tracks, or otherwise facilitates development of computer code included in the one or more target and or source repositories. The version control service may be any publicly available version control service (e.g., GitHub, GitLab, Bitbucket, SourceForge, and the like) or proprietary version control service. The version control service API 304 monitors source repositories managed by the version control service to identify source repositories including code submissions having translation requests. For example, the version control service API may identify one or more machine translation labels or tags applied to code submissions included in the source repositories. FIG. 5 illustrates an example screenshot of a repository management UI 500 included in a version control service. The repository management UI 500 shows a machine translation label 502 to be added to a code submission (“code submission A”) by a developer (“User AAA”) working on two merging code submissions into a target repository.

Referring again to FIG. 3, when a machine translation label 502 is added to a code submission, the version control service API 304 receives a notification and generates a translation request 320A, . . . , 320N. The notification may be associated with a particular translation request 320A. Each translation request 320A, . . . , 320N may include a code submission 322 and translation meta-data 328. To generate the translation requests 320A, . . . , 320N, the version control service API 304 accesses the source repository storing the code submission 322 and copies one or more files in the source repository that are changed or added by the code submission 322. The one or more files may include executable code 324 (i.e., computer code that is not translatable) and translatable strings 326 (i.e., text strings that may be translated to a plurality of languages).

The version control service API 304 may also retrieve the configuration information of the source repository and or one or more target repositories receiving the code submission from the version control service. For example, the repositories' configuration information may include a list of file names or other identifiers, a file hierarchy, and or another organizational structure that identifies the files included in source repository that have translatable strings 326. The configuration information may also include location and or language settings of the source repository and the target repositories. The configuration information obtained from the source and or target repositories may be added to the translation request as translation meta-data 328.

Translation requests 320A, . . . , 320N are received by the machine translation system 306 from the version control service. Upon receipt of each translation request 320A, . . . , 320N, the machine translation system 306 generates a translation event that initiates the translation engine 330. To maximize the speed and efficiency of the translation engine 330, a dispatcher 346 may schedule the translation requests 320A, . . . , 320N for processing by the translation engine 330. The dispatcher 346 may also format translation requests 320A, . . . , 320N for batch processing by the translation engine 330. For example, the dispatcher 346 may divide translation requests into 320A, . . . , 320N batches that may be processed in parallel by multiple servers running multiple instances of the translation engine 330. The dispatcher 346 may also divide a single translation request 320A into multiple batches. For example, the dispatcher 346 may divide translatable strings 326 from one or more translation requests 320A, . . . , 320N into batches. The translation requests 320A, . . . , 320N and or translatable strings 326 included in each batch may be processed together by the translation engine 330 to translate the translatable strings 326 included in each batch. For example, the translation requests and or translatable strings 326 may be processed together (i.e., simultaneously in parallel and or consecutively) using a batch translation process

The dispatcher 346 may schedule translation requests 320A, . . . , 320N based on a predetermined priority level associated with a particular translation request 320A, and or a particular source and or target repository. The dispatcher 346 may also queue and schedule batch processing of multiple batches of translation requests 320A, . . . , 320N and or translatable strings 326 according to the translation parameters included in the translation meta-data. For example, the dispatcher 346 may queue translation requests 320A, . . . , 320N and or translatable strings 326 based on the locations, languages, and or file types included in each translation request to make sure the translation requests 320A, . . . , 320N and or translatable strings 326 are routed to the correct language model 342A, . . . , 342N for translation. The dispatcher 346 may also schedule translation requests 320A, . . . , 320N and or translatable strings 326 based on the processing capacity, batch size, or other configurations of the translation engine 330. For example, the dispatcher 346 may schedule translation requests 320A, . . . , 320N and or translatable strings 326 for processing by the translation engine 330 to load balance processing of translation requests 320A, . . . , 320N and or translatable strings 326 by multiple servers hosting multiple instances of the translation engine 330. To balance the processing load across multiple instances of the translation engine 330, the dispatcher 346 may limit the number of translation requests 320A, . . . , 320N and or translatable strings 326 that are pushed to each instance of the translation engine 330.

The dispatcher 346 may also schedule translation requests 320A, . . . , 320N and or translatable strings 326 according to the configuration information of the source and or target repository identified in the translation meta-data. For example, the dispatcher 346 may schedule processing of translation requests 320A, . . . , 320N and or translatable strings 326 to limit the number of translation jobs running for a particular target and or source repository. The dispatcher 346 may also schedule translation requests 320A, . . . , 320N and or translatable strings 326 for batch processing by the translation engine 330 according to one or more scheduling rules (e.g., capacity of each translation engine, maximum number of translation jobs for each source and or target repository, and the like) of the dispatcher 346. The dispatcher may also schedule translation requests 320A, . . . , 320N and or translatable strings 326 based on one or more scheduling rules that minimize the number of redundant translations. The dispatcher 346 reduces the overall processing time for each translation request 320A, . . . , 320N and each string included in the translatable strings 326. The dispatcher 346 also reduces the processing resources (processing capacity, memory allocation, and storage) consumed while processing each of the translation requests 320A, . . . , 320N and translatable strings 326 by efficiently scheduling and distributing the translation requests 320A, . . . , 320N and translatable strings 326 to multiple servers running multiple instances of the translation engine 330.

The dispatcher 346 may also streamline machine translations by spinning up an ephemeral translation processing infrastructure for each translation request 320A, . . . , 320N. The ephemeral translation processing infrastructure facilitates extracting and translating the translatable strings 326 included the translation request 320A. The ephemeral infrastructure includes a container or other unit of software having all of the tools, resources, and data needed to process a translation job. For example, the container may include all code modules, system tools, system libraries, configuration settings, and other data needed to access the files requiring translation, extract the translatable strings 326, and translate the translatable strings 326. The containers are pushed to a particular processor (e.g., a host server) to execute the operations of the translation process. The container may streamline machine translations by dividing translation requests 320A, . . . , 320N into batches that may be efficiently processed by the translation engine 330. The container may include a standard set of tools, resources, and data that are required to automatically configure and execute each batch of translation requests 320A, . . . , 320N using a batch process. The container and other components of the processing infrastructure may be automatically torn down once the translation requests 320A, . . . , 320N are completed. Tearing down the ephemeral translation processing infrastructure after each translation job conserves computational resources (i.e., processing power, storage, and memory) and reduces the cost of operating the machine translation system 306 by eliminating resources required to maintain unused containers and other translation processing infrastructure. The container reduces the processing time for completing translation requests 320A, . . . , 320N by eliminating operations required to determine custom configurations for each of the translation requests 320A, . . . , 320N. The container also reduces processing resources (e.g., processor capacity, memory allocation, and storage) needed to complete the translation requests 320A, . . . , 320N by limiting the size of the translation infrastructure to fit the number of outstanding translation requests 320A, . . . , 320N.

To begin translation, the files included in the code submission 322 are digested by a content localization service 332. For example, an extraction module 334 of the content localization service 332 may separate the translatable strings 326 from the executable code 324. The translatable strings 326 are then added to a translation file 336 that organizes the translatable strings 326 into a common object or other standard format to facilitate translation by the translation module 340. The extraction module 334 may extract the translatable strings 326 by slicing entire files and or portions of files and or portions of lines included in files that have translatable strings 326 from the executable code 324 and other non-translatable aspects of the code submission 322. The translatable strings 326 extracted from the code submission 322 are then aggregated and arranged as a common object or other structured format (e.g., JSON, XML, and the like) to generate the translation file 336. The extraction module 334 may clean or otherwise process the translatable strings 326 as the strings are added to the translation file 336. For example, the extraction module 334 may standardize and or remove symbols, abbreviations, acronyms, and other special characters included in the translatable strings 326 before the translatable strings 326 are written to the translation file 336. The translation file 336 may be read by both humans and machines so that portions of the same translation file 336 may be translated using both automated and manual translation methods. The common object format of the translation file 336 also enables the extracted translatable strings 326 to be reviewed for accuracy by both humans and machines. Therefore, automated and manual methods are used to verify the correct translatable strings 326 were extracted from the files of the code submission 322.

The translation file 336 is sent to the translation module 340 for translation. The translation module 340 includes multiple language models 342A, . . . , 342N for translating the translatable strings 326. The language models 342A, . . . , 342N may be specific to a particular language, location, and or subject matter (e.g., accounting, tax, law, medicine, sports, and the like). The language models 342A, . . . , 342N may be one or more machine learning models trained to perform translation tasks. For example, the language models 342A, . . . , 342N may be generated using a deep learning system including one or more recurrent neural networks, transformers, and or attention mechanisms. The language models 342A, . . . , 342N may also include a transformer system or other neural network having multiple encoder layers connected to multiple decoder layers. Other machine learning model architectures including different types and or combinations of network layers may also be included in the language models 342A, . . . , 342N.

In one embodiment, the language models 342A, . . . , 342N may receive the translatable strings 326 as inputs and may generate translation results for the translatable strings using one or more encoder and or decoder layers. The one or more encoder layers encode each received translatable string based one or more representations of meaning (e.g., embeddings, vectors, and the like) derived from a set of training data (e.g., a training dataset including domain specific text written in the same language as the translatable strings). The one or more decoder layers of the language models 342A, . . . , 342N then decode the encoded translatable strings 326 using one or more representations of meaning (e.g., embeddings, vectors, and the like) derived from a second set of training data (e.g., a training dataset including domain specific text written in the language selected for translation) to generate the translation results. The translation results may include multiple translated strings 354 that express the text included in the translatable strings 326 in another language.

To improve the efficiency of the translation module 340 and increase the speed of the translations provided by the language models 342A, . . . , 342N, information stored in translation memories 344 is used to translate some and or all of the translatable strings 326 included in the translation file 336. The translation memories 344 include previously generated translation results that are stored in memory and may be accessed by the language models 342A, . . . , 342N to instantaneously generate translations for translatable strings 326. To avoid redundant translation operations, the translation module 340 first obtains translation results for any translatable strings 326 having results stored in the translation memories 344 then translates the remainder of the translatable strings 326 using the language models 342A, . . . , 342N. To minimize the amount of translations that must be generated by the language models 342A, . . . , 342N, the results of the most recently and or frequently translated strings may be stored in translation memories 344. The translation results stored in the translation memories 344 may be specific to a particular source repository, target repository, subject matter domain, and the like. Translation memories 344 are also used to improve the accuracy of translations generated by the translation module 340. For example, manual translation results for domain specific expressions and or vocabulary terms that do not literally translate between two languages may be included in translation memories 344 to avoid inaccurate results that may be generated by the language models 342A, . . . , 342N.

Translatable strings 326 that may not be translated using the translation memories 344 are translated using the language models 342A, . . . , 342N to generate translated strings 354. Translated strings 354 generated by the translation module 340 include translations for each translatable string included in the translation file 336. Each translatable string included in the translation file 336 may be translated into multiple languages and or location-specific versions of a particular language (e.g., Canadian French, Australian English, US English, and the like). The translated strings 354 are integrated into the non-translatable aspects of the original code submission 322.

The translated strings 354 are integrated into the original code submission 322 by a reconstruction module 338 included in the content localization service 332. The reconstruction module 338 constructs a translated code submission 352A, . . . , 352N for each set of translated strings 354 generated by the translation module 340. For example, if the original code submission 322 is distributed to five different language-specific target repositories, the translation module 340 generates five different sets of translated strings 354 and the reconstruction module 338 generates five different translated code submissions 352A, . . . , 352N. To generate the translated code submissions 352A, . . . , 352N, the reconstruction module 338 reconstructs the files of the code submission 322 with the translatable strings 326 in the code submission 322 replaced by the translated strings 354. The translated code submissions 352A, . . . , 352N generated by the reconstruction module 338 are included in merge requests 350 that push the translated code submissions 352A, . . . , 352N to a target repository managed by the version control service.

The merge requests 350 generated by the translation engine 330 send a notification to the version control service API 304 to integrate the translated code submissions 352A, . . . , 352N into a target repository. The target repository may have configuration settings specifying the same language and or location as the translated strings 354 included in the translated code submission 352A. The version control service API 304 accesses the target repository to perform the integration and push the translated code submission 352A to the target repository so the version control service can update the repository with the changes and or additions included in the translated code submission 352A. For code submissions that are integrated into multiple target repositories (e.g., target repositories including different language versions of the same software product), the machine translation system 330 generates multiple translated code submissions 352A, . . . , 352N and multiple merge requests 350 for each translation request 320A. The version control service API 304 may also push the same merge request 350 to multiple target repositories (e.g., target repositories storing a testing and deployment version of a software product).

Translating the translatable strings 326 before pushing the code submission 322 to the target repository streamlines the development process by eliminating the need for manual and or ad hoc translation during the development process. It also streamlines the testing and deployment of updates to software platforms included in the target repository by providing real time translations. The disclosed integrated machine translation approach also enables developers to immediately test newly merged translated code submissions instead of having to wait for translations of un-translated code submissions that were previously merged. The disclosed integrated machine translation approach also improves the accuracy of translations and the quality of the software platforms incorporating the changes included in the code submissions. For example, the machine translation system 306 automatically detects and translates all translatable strings 326 in the code submission 322 to ensure no untranslated text is incorporated into the software platform. The domain specific knowledge used to train the language models 342A, . . . , 342N also improves the accuracy of translations relative to other machine translation techniques. Additionally, the specialized translation results included in the translation memories 344 provide instantaneous translation results for semantic enigmas (i.e., words that have not literal translation in another language) and other difficult translations.

FIG. 4 illustrates more details of the content localization service 332 included in the machine translation system. As described above, the content localization service 332 and the translation module 340 generate merge requests 350 including translated versions of code submissions received from one or more source repositories 402. To generate translated code submissions, a file parser 404 included in the extraction module 334 digests files from the source repositories 402 included in the translation requests 320A, . . . , 320N. For example, the file parser 404 may read a file list, file hierarchy, and or other organizational structure to extract particular files including translatable strings. The file parser 404 may also parse JSON, XML, or other structured data formats to slice particular portions of files and or portions of lines included in the files to identify and extract translatable strings 326. Translatable strings 326 extracted by the file parser 404 are then cleaned, aggregated, and organized into a standard file format by a file generator 406 to generate a translation file 336.

The translatable strings 326 included in the translation file are translated by the translation module 340 to generate translated strings 354. An encoder 408 included in the reconstruction module 338 encodes the translated strings 354 into the same structured format (e.g., JSON, XML, and the like) as the translatable strings 326 extracted from the files included in the translation request 320A, . . . , 320N. For example, if the translated strings 354 are generated as an XML file and the translatable strings 326 were extracted from a JSON file, the encoder 408 rewrites the translated strings as a JSON file having the same format as the file in the code submission that included the translated strings 354. The structured translation results 410 generated by the encoder 408 are combined with the non-translatable aspects of the code submission (e.g., files containing executable computer code) included in the translation request 320A by the file constructor 412 to generate the translated version of the code submission. The translated version of the code submission is included in a merge request 350. The merge request 350 pushes the translated code submission to one or more target repositories 414. Once pushed to the target repositories 414, the translated code submissions are incorporated into the software platform stored in the target repositories 414.

FIG. 6 shows an example computing device according to an embodiment of the present disclosure. For example, computing device 600 may function as client device 250, first server 220, and or second server 230. The computing device 600 may include a machine translation system that executes the integrated machine translation process described above or a portion or combination thereof in some embodiments. The computing device 600 may be implemented on any electronic device that runs software applications derived from compiled instructions, including without limitation personal computers, servers, smart phones, media players, electronic tablets, game consoles, email devices, etc. In some implementations, the computing device 600 may include one or more processors 602, one or more input devices 604, one or more display devices 606, one or more network interfaces 608, and one or more computer-readable mediums 612. Each of these components may be coupled by bus 610, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, camera, and touch-sensitive pad or display. Bus 610 may be any known internal or external bus technology, including but not limited to ISA, EISA, PCI, PCI Express, USB, Serial ATA or FireWire. Computer-readable medium 612 may be any non-transitory medium that participates in providing instructions to processor(s) 604 for execution, including without limitation, non-volatile storage media (e.g., optical disks, magnetic disks, flash drives, etc.), or volatile media (e.g., SDRAM, ROM, etc.).

Computer-readable medium 612 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 612; controlling peripheral devices (e.g., disk drives, printers, etc.) which can be controlled directly or through an I/O controller; and managing traffic on bus 610. Network communications instructions 616 may establish and maintain network connections (e.g., software for implementing communication protocols, such as TCP/IP, HTTP, Ethernet, telephony, etc.).

Machine translation instructions 618 may include instructions that enable computing device 600 to function as a machine translation system and/or to provide machine translation system functionality as described herein. Application(s) 620 may be an application that uses or implements the processes described herein and/or other processes. The processes may also be implemented in operating system 614. For example, application 62 and/or operating system may present UIs 152 for generating translation requests and reviewing translated code submissions as described herein.

Embodiments described herein translate text strings and other translatable portions of code submissions into one or more desired languages. The code submissions may include multiple files that form one or more features and or components of a software platform. The translated code submissions are integrated into one or more target repositories storing location-specific versions of the software platform to ensure that the text and other translatable components of the software platform released in a particular location is in the local language of the particular location. For example, code submissions that are translated into Portuguese are integrated into the Brazil version of a software platform to ensure that the text included in the Brazil version of the platform is in Portuguese (i.e., the local language of Brazil). The translated code submissions are generated using the machine translation approach disclosed herein. By streamlining development and maintenance of global software platforms having many different language variations, the machine translation approach builds trust and confidence among users in different countries. The machine translation approach also makes software platforms more accessible to new users in different markets and improves user experience by making the features of the platform easier and more enjoyable to use.

The disclosed machine translation approach used to generate translated code submissions is integrated into a software development process. The integrated machine translation approach reduces development time and resources by automatically extracting and translating text strings included in newly developed code submissions. The integrated machine translation approach slices files included in code submissions submitted by developers to automatically extract text strings and other translatable aspects of code submissions. The extracted text strings are aggregated in a common object (e.g., a JSON or XML file) or other structured data format. The common object may be processed by one or more computer systems for machine translation and or humans for manual translation.

The integrated machine translation approach translates the text strings included in the common object into a plurality of languages and generate translated versions of the code submissions that include the translated text. The translated code submissions are merged into target repositories including location-specific versions of a software platform for testing and release to production. By providing instant translation of text strings included in code submissions, the machine translation approach improves the translation speed and accuracy relative to manual translation methods (e.g., copy and paste from a translation service). For example, replacing the translation step in the current development process (i.e., manually reviewing code to identify and extract translatable strings, copying and pasting the extracted strings into a machine translation service to translate the strings, and re-integrating the translated strings back into the developed code) with the disclosed integrated machine translation approach saves thousands of hours in development time per year for development teams working on global software platforms that are deployed in multiple countries.

The integrated machine translation approach also improves the quality of location-specific versions of software platforms by ensuring that all of the text included in the location-specific version of the software platform is translated before the code submission is merged into the production version of the software platform. The integrated machine translation approach may also push the translated code submissions directly to a target repository that may include a testing version of the software platform to enable the translations to be reviewed before the code submission is merged into the production version of the software platform and released to users. Testing the translated code submissions before release to production ensures that the text strings are fully and accurately translated before they are seen by users. Additionally, the integrated machine learning approach improves upon manual and or other machine translation techniques, that only provide translations, by helping developers identify and correct programming and other errors caused by translations during the development process. For example, errors in alignment, spacing, and sizing of text included in user interface (UI) components caused by differences in the string length and or number of characters required to represent the same string of text in different languages may be identified and resolved using the integrated machine translation approach disclosed herein.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer implemented method of performing a machine translation of a code submission, the method comprising:
receiving a translation request comprising the code submission and translation meta-data, the code submission having multiple translatable strings and multiple lines of computer code;
extracting the multiple translatable strings from the code submission;
determining a language combination for translating the multiple translatable strings based on the translation meta-data;
translating the multiple translatable strings according to the language combination to generate multiple translated strings; and
integrating the multiple translated strings with the multiple lines of computer code to generate a translated code submission.

2. The method of claim 1, further comprising:
generating a merge request that includes the translated code submission; and
integrating the translated code submission into a target repository identified in the translation meta-data based on the merge request.

3. The method of claim 1, further comprising:
generating a translation file that aggregates the multiple translatable strings into a common object; and
using the common object in a translation process that includes machine translation and human translation.

4. The method of claim 1, further comprising:
dividing the multiple translatable strings into multiple batches, wherein each batch includes two or more of the multiple translatable strings that are processed together; and
scheduling a batch translation process based on the translation meta-data, wherein the batch translation process translates the two or more of the multiple translatable strings included in each batch.

5. The method of claim 1, wherein the translation request is received from a source repository and said method further comprises:
receiving a notification associated with the translation request from the source repository;
accessing the source repository and a target repository to obtain the translation meta-data, the translation meta-data comprising a language and a location associated with the source repository and a language and a location associated with the target repository; and
determining the language combination from the language and the location associated with the source repository and the language and the location associated with the target repository.

6. The method of claim 1, wherein the translation request is received from a source repository, the code submission comprises multiple files, and the method further comprises:
parsing a file organization structure included in the source repository to identify at least one file included in the multiple files that has at least one translatable string; and
extracting the at least one file from the source repository to translate the at least one translatable string included in the at least one file.

7. The method of claim 1, wherein the translation meta-data identifies a target repository that receives the translated code submission, the target repository stores a testing version of a software platform and the method further comprises:
integrating the translated code submission into the target repository; and
testing the translated code submission to identify at least one error in the translated code submission.

8. The method of claim 7, wherein the at least one error includes at least one of a translation bug included in the multiple translated strings or a programming bug included in the multiple lines of computer code that is caused by the multiple translated strings.

9. The method of claim 7, further comprising:
identifying the at least one error in the translated code submission;
modifying the translated code submission to fix the at least one identified error;
merging the modified translated code submission to the target repository; and
re-testing the modified translated code submission to identify at least one error in the modified translated code submission.

10. The method of claim 1, wherein the translation meta-data identifies a target repository that receives the translated code submission, wherein the target repository stores a testing version of a software platform and the method further comprises:
integrating the translated code submission into the target repository;
testing the translated code submission;
determining that the translated code submission does not include at least one error; and
releasing the translated code submission to a production version of the software platform.

11. The method of claim 1, wherein the translation meta-data specifies multiple target repositories for receiving the code submission, wherein each target repository of the multiple target repositories is associated with a different language.

12. The method of claim 1, further comprising:
querying a set of translation memories to receive a translation result for at least one translatable string, the set of translation memories including multiple previously generated translation results; and
translating a remainder of the multiple translatable strings by generating translation results for the remainder of the multiple translatable strings using one or more language models.

13. A system for performing machine translation of a code submission, said system comprising:
a repository configured to store a translation request including a code submission and translation meta-data; and
a machine translation system, executing on a processor and being configured to:
receive, from a source repository coupled to the machine translation system via a network interface, a translation request including a code submission and translation meta-data, the code submission having multiple translatable strings combined with multiple lines of computer code;
extract the multiple translatable strings from the code submission;
determine a language combination for translating the multiple translatable strings based on the translation meta-data;
translate the multiple translatable strings according to the language combination to generate multiple translated strings; and
integrate the multiple translated strings with the multiple lines of computer code to generate a translated code submission.

14. The system of claim 13, wherein the machine translation system is further configured to:
generate a merge request that includes the translated code submission; and
integrate the translated code submission into a target repository identified in the translation meta-data based on the merge request.

15. The system of claim 13, wherein the network interface is coupled to a target repository and the machine translation system is further configured to:
receive a notification associated with the translation request from the source repository;
access the source repository and a target repository to obtain the translation meta-data, the translation meta-data comprising a language and a location associated with the source repository and a language and a location associated with the target repository; and
determine the language combination from the language and the location associated with the source repository and the language and location associated with the target repository.

16. The system of claim 13, wherein the machine translation system is further configured to:
generate a translation file that aggregates the multiple translatable strings into a common object; and
use the common object in a translation process that includes machine translation and human translation.

17. The system of claim 13, wherein the machine translation system is further configured to:
divide the multiple translatable strings into multiple batches, wherein each batch includes two or more of the multiple translatable strings that are processed together; and
schedule a batch translation process based on the translation meta-data, wherein the batch translation process translates the two or more of the multiple translatable strings included in each batch.

18. The system of claim 13, wherein the code submission comprises multiple files, and the machine translation system is further configured to:
parse a file organization structure included in the source repository to identify at least one file included in the multiple files that has at least one translatable string; and
extract the at least one file from the source repository to translate the at least one translatable string included in the at least one file.

19. The system of claim 13, wherein the network interface is coupled to a target repository that stores a testing version of a software platform and the machine translation system is further configured to:
integrate the translated code submission into the target repository; and
test the translated code submission to identify at least one error in the translated code submission.

20. The system of claim 19, wherein the at least one error includes at least one of a translation bug included in the multiple translated strings or a programming bug included in the multiple lines of computer code that is caused by the multiple translated strings.

21. The system of claim 19, wherein the machine translation system is further configured to:
identify the at least one error in the translated code submission;
modify the translated code submission to fix the at least one identified error;
merge the modified translated code submission to the target repository; and
retest the modified translated code submission to identify at least one error in the modified translated code submission.

22. The system of claim 13, wherein the network interface is coupled to a target repository that stores a testing version of a software platform and the machine translation system is further configured to:
integrate the translated code submission into the target repository;
test the translated code submission;
determine that the translated code submission does not include at least one error; and
release the translated code submission to a production version of the software platform.

23. The system of claim 13, wherein the translation meta-data specifies multiple target repositories for receiving the code submission, wherein each target repository of the multiple target repositories is associated with a different language.

24. The system of claim 13, wherein the repository is configured to store:
a set of translation memories including multiple previously generated translation results; and
one or more language models; and
wherein the machine translation system is further configured to query the set of translation memories to receive a translation result for at least one translatable string; and
translate a remainder of the multiple translatable strings by generating translation results for the remainder of the multiple translatable strings using one or more language models.
